(19) United States
(12) Patent Application Publication
(10) Pub. No.: US 2005/0239585 A1
(43) Pub. Date: Oct. 27, 2005

(54) V-belt type automatic transmission

(75) Inventors: Tetsushi Nishida, Wako-shi (JP); Hideo Ishikawa, Wako-shi (JP); Michio Asumi, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 11/112,206

(22) Filed: Apr. 22, 2005

(30) Foreign Application Priority Data
Apr. 26, 2004 (JP) 2004-130290

(51) Int. Cl. F16H 55/56; F16H 63/00; F16H 9/12

(52) U.S. Cl. 474/19; 474/8; 474/37; 474/12; 474/46

(57) ABSTRACT

The shift response in a V-belt type automatic transmission is improved using a double cogged V-belt having an endless core wire embedded portion in which core wires are embedded, a lower cog formed portion provided over the inner circumference of the core wire embedded portion, and an upper cog formed portion provided over the outer circumference of the core wire embedded portion, as a V-belt for transmitting power from a drive pulley device to a driven pulley device. Each of the core wires is formed from aramid fibers, and the ratio (W/T) of the width W of the V-belt to the thickness T of the V-belt is set to 2.5 or less.

### FIELD OF THE INVENTION

The present invention relates to a V-belt type automatic transmission, and more particularly to a V-belt type automatic transmission using a double cogged V-belt having an endless core wire embedded portion in which core wires are embedded, a lower cog formed portion provided over the inner circumference of the core wire embedded portion, and an upper cog formed portion provided over the outer circumference of the core wire embedded portion, as a V-belt for transmitting power from a drive pulley device to a driven pulley device.

### BACKGROUND OF THE INVENTION

A V-belt type automatic transmission using a double cogged V-belt having outer cogs is known. Japanese Patent Laid-Open No. 2004-36855 discloses the conditions for forming a double cogged V-belt having high bending resistance and increased transmitting capacity. However, when a double cogged V-belt is applied to a V-belt type automatic transmission, it is also necessary to improve the shift response. Any configuration for solving such a problem is not disclosed in the Japanese patent.

It is therefore an object of the present invention to provide a V-belt type automatic transmission which can improve the shift response.

### SUMMARY OF THE INVENTION

To provide a V-belt type automatic transmission which can improve the shift response, there is provided a V-belt type automatic transmission including a drive pulley device having a first fixed pulley member and a first movable pulley member opposed to the first fixed pulley member with the distance therebetween being changeable; a driven pulley device having a second fixed pulley member, a second movable pulley member rotatable relative to the second fixed pulley member about an axis thereof and axially movable relative to the second fixed pulley member, a torque cam mechanism for applying an axial component force to the second fixed pulley member and the second movable pulley member according to a relative rotational phase difference between the second fixed pulley member and the second movable pulley member, and a coil spring for exerting a spring force for biasing the second movable pulley member toward the second fixed pulley member; and a double cogged V-belt wrapped between the drive pulley device and the driven pulley device so as to be nipped between the first fixed pulley member and the first movable pulley member and between the second fixed pulley member and the second movable pulley member, the double cogged V-belt having an endless core wire embedded portion in which core wires are embedded, a lower cog formed portion provided over the inner circumference of the core wire embedded portion, and an upper cog formed portion provided over the outer circumference of the core wire embedded portion; wherein each of the core wires is formed from aramid fibers, and the ratio (W/T) of the width W of the V-belt to the thickness T of the V-belt is set to 2.5 or less.

The core wires of the double cogged V-belt are formed from aramid fibers, so that the stiffness of the V-belt can be set relatively high. Furthermore, the ratio (W/T) of the width W of the V-belt to the thickness T of the V-belt is set to 2.5 or less, so that the deformation of the V-belt with changes in load can be suppressed. As a result, in response to fluctuations of input torque from the drive pulley device, the V-belt can suitably transmit power to the driven pulley device so that the torque can mechanism generates a suitable axial component force, thus extending the life of the V-belt and improving the shift response.

The drive pulley device of the V-belt type automatic transmission device may include either a centrifugal weight for changing the distance between the first fixed pulley member and the first movable pulley member or an actuator for changing the distance between the first fixed pulley member and the first movable pulley member according to a shift command.

The double cogged V-belt can be used commonly for the drive pulley device having the centrifugal weight for changing the distance between the first fixed pulley member and the first movable pulley member and for the drive pulley device having the actuator for changing the distance between the first fixed pulley member and the first movable pulley member according to a shift command. Accordingly, the number of kinds of parts can be reduced.

The torque cam mechanism of the drive pulley device of the V-belt type automatic transmission device may include different torque cam angles according to which of the centrifugal weight and the actuator is included in the drive pulley device. Accordingly, it is only necessary to prepare the torque cam mechanisms having different torque cam angles respectively for the drive pulley device having the centrifugal weight for changing the distance between the first fixed pulley member and the first movable pulley member and the drive pulley device having the actuator for changing the distance between the first fixed pulley member and the first movable pulley member according to a shift command, and the other components of these drive pulley devices can be used commonly. Further, suitable axial component forces can be generated by the torque cam mechanisms in these driven pulley devices.

### BRIEF DESCRIPTION OF THE DRAWINGS

FIG. 1 is a side view of a power unit and a rear wheel.

FIG. 2 is a cross section taken along the line 2-2 in FIG. 1.

FIG. 3 is an enlarged view of an essential part shown in FIG. 2.

FIG. 4 is a cross section taken along the line 4-4 in FIG. 3.

FIG. 5 is a cross section taken along the line 5-5 in FIG. 3.

FIG. 6 is an enlarged horizontal sectional view of a driven pulley device.

FIG. 7 is a vertical sectional view of an outer sleeve and a movable pulley member constituting a part of the driven pulley device shown in FIG. 6.

FIG. 8 is a longitudinal sectional view of a double cogged V-belt.

FIG. 9 is a cross section taken along the line 9-9 in FIG. 8.

FIG. 10(a) is a transverse sectional view of the double cogged V-belt in the condition where no load is applied.

FIG. 10(a) is a transverse sectional view of the double cogged V-belt in its deformed condition for illustrating the deformation by a load applied.

FIG. 11 is a graph showing the deformation characteristics of the double cogged V-belt according to changes in the load applied.

FIG. 12 is a sectional view similar to FIG. 2, showing a modification of the V-belt type automatic transmission.

FIG. 13 is a vertical sectional view of an outer sleeve and a movable pulley member constituting a part of a driven pulley device shown in FIG. 12.

FIG. 14 is a side view of a case cover and a sound insulating cover as taken along the line 14-14 in FIG. 2.

FIG. 15 is another side view of the case cover and the sound insulating cover as taken along the line 15-15 in FIG. 2.

FIG. 16 is a graph showing the rest results of noise measurement.

### DETAILED DESCRIPTION OF THE INVENTION

A preferred embodiment of the present invention will now be described with reference to the attached drawings.

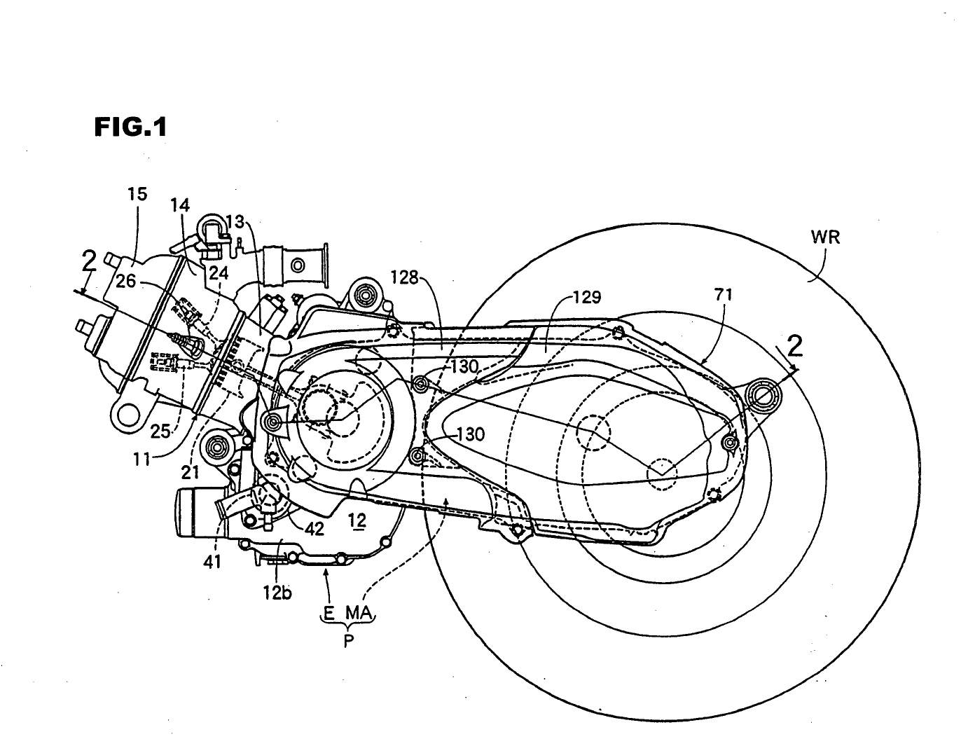

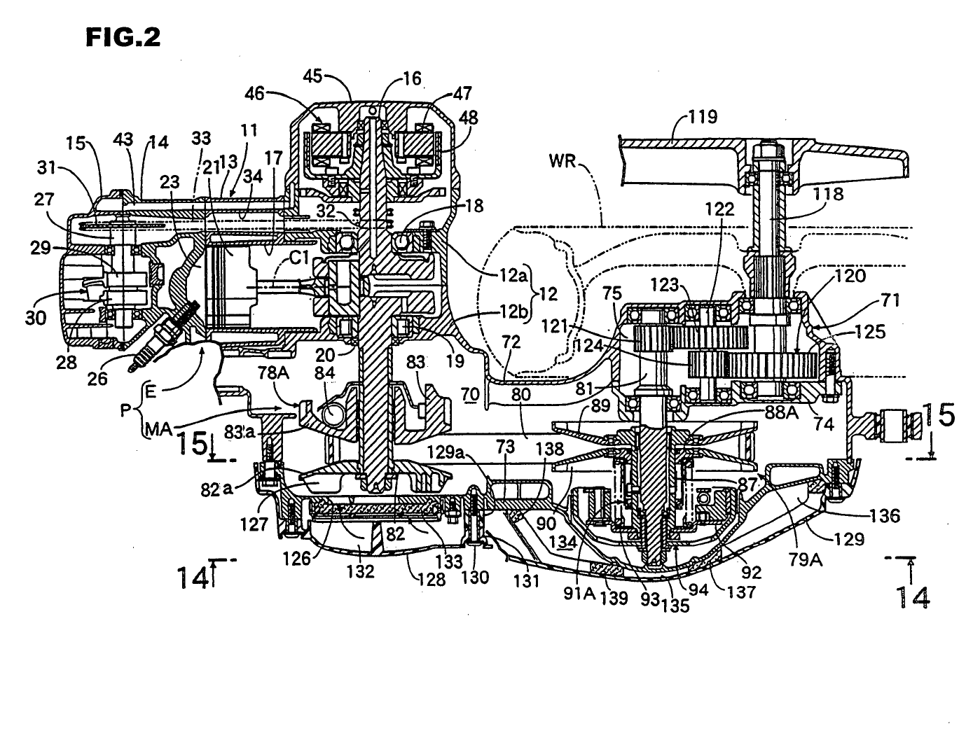

Referring first to FIGS. 1 and 2, a power unit P is constituted of an engine E and a V-belt type automatic transmission MA. The engine E is located on the front side of a rear wheel WR as a drive wheel. The V-belt type automatic transmission MA is provided between the engine E and the rear wheel WR. The power unit P is mounted on a body frame (not shown) of a scooter type motorcycle. The rear wheel WR is located on the right side of a rear portion of the power unit P and is rotatably supported to the rear portion of the power unit P.

The engine E has an engine body 11, which includes a crankcase 12 rotatably supporting a crankshaft 16 having an axis of rotation parallel to the axis of rotation of the rear wheel WR, a cylinder block 13 connected to the crankcase 12, a cylinder head 14 connected to the cylinder block 13 opposite to the crankcase 12, and a head cover 15 connected to the cylinder head 14 opposite to the cylinder block 13.

The cylinder block 13 is arranged so that the axis of a cylinder bore 17 formed in the cylinder block 13, i.e., the cylinder axis C1 substantially horizontally extends in the longitudinal direction of the motorcycle so as to be slightly inclined up on the front side. The crankcase 12 is composed of a pair of case members 12a and 12b connected together in a plane containing the cylinder axis C1 and orthogonal to the axis of the crankshaft 16. A ball bearing 18 is interposed between the case member 12a and the crankshaft 16, and a roller bearing 19 and an annular seal member 20 are interposed between the case member 12b and the crankshaft 16. The annular seal member 20 is located axially outside of the roller bearing 19.

A piston 21 is slidably fitted in the cylinder bore 17, and a combustion chamber 23 is formed between the cylinder head 14 and the piston 21. An intake valve 24 for controlling the intake into the combustion chamber 23 and an exhaust valve 25 for controlling the exhaust from the combustion chamber 23 are provided in the cylinder head 14 so as to form a substantially V-shaped arrangement on a plane orthogonal to the axis of the crankshaft 16. A spark plug 26 exposed to the combustion chamber 23 is mounted on the left side surface of the cylinder head 14 so as to project frontward of the motorcycle in the running direction thereof.

A valve train 30 is accommodated between the cylinder head 14 and the head cover 15 so as to operate the intake valve 24 and the exhaust valve 25. The valve train 30 includes a camshaft 27 having an axis parallel to the axis of the crankshaft 16 and rotatably supported to the cylinder head 14. The camshaft 27 has an intake cam 28 and an exhaust cam 29.

A driven sprocket 31 is fixed to the camshaft 27 at one end thereof. On the other hand, a first drive sprocket 32 is fixed to the crankshaft 16 at a position axially outside of the ball bearing 18 in corresponding relationship with the driven sprocket 31. An endless cam chain 33 is wrapped between the first drive sprocket 32 and the driven sprocket 31. The cam chain 33 is operably accommodated in a chain chamber 34 formed over the cylinder block 13, the cylinder head 14, and the head cover 15. The camshaft 27 is rotationally driven by the first drive sprocket 32, the driven sprocket 31, and the cam chain 33 at a rotational speed half that of the crankshaft 16.

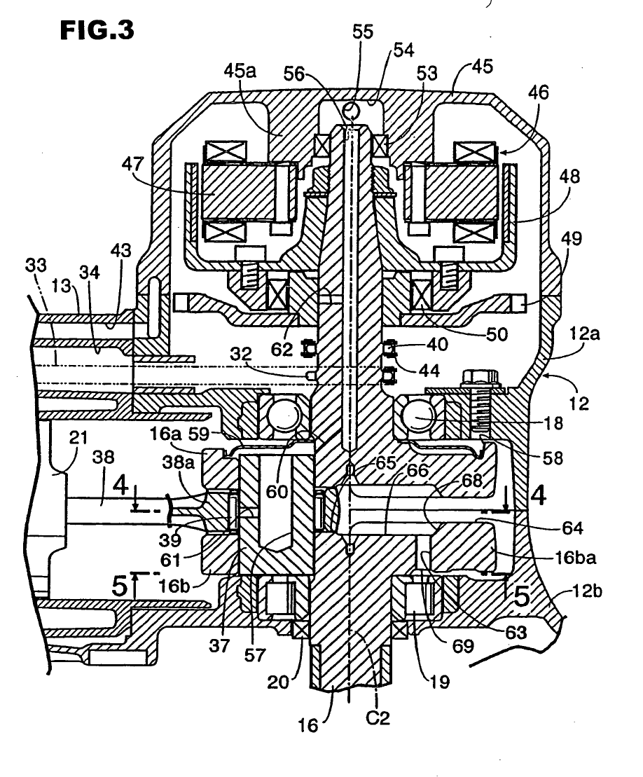

Referring also to FIG. 3, the crankshaft 16 has a pair of crank webs 16a and 16b axially opposed to each other with a spacing defined therebetween. A crankpin 37 is connected at both ends thereof to the crank webs 16a and 16b. On the other hand, a connecting rod 38 is connected at one end thereof to the piston 21, and the other end, or big end 38a of the connecting rod 38 is connected through a needle bearing 39 to the crankpin 37.

A second drive sprocket 40 is fixed to the crankshaft 16 at a position axially outside of the first drive sprocket 32. An oil pump 41 (see FIG. 1) for raising oil from a lower portion of the crankcase 12 and a cooling water pump 42 (see FIG. 1) for circulating a cooling water to a cooling water jacket 43 formed in the cylinder block 13 and the cylinder head 14 are coaxially provided at the lower portion of the crankcase 12. Torque of the crankshaft 16 is transmitted from the second drive sprocket 40 through a chain 44 to the oil pump 41 and the cooling water pump 42.

A generator 46 is provided axially outside of the second drive sprocket 40. The generator 46 includes a stator 47 fixed to a right cover 45 mounted on the right side surface of the crankcase 12 and an outer rotor 48 fixed to the crankshaft 16 so as to surround the stator 47.

A driven gear 49 is located between the second drive sprocket 40 and the outer rotor 48. The driven gear 49 is relatively rotatably supported to the crankshaft 16 so as to coaxially surround the crankshaft 16. The driven gear 49 is connected through a one-way clutch 50 to the outer rotor 48. Torque from a starter motor (not shown) is adapted to be input to the driven gear 49. At starting the engine E, the drive force from the starter motor is transmitted to the crankshaft 16. After starting the engine E, torque of the crankshaft 16 is prevented from being transmitted to the starter motor owing to the operation of the one-way clutch 50.

The right cover 45 is integrally formed with a cylindrical supporting portion 45a. The cylindrical supporting portion 45a projects from the inner surface of the right cover 45 at a central portion thereof so as to surround a right end portion of the crankshaft 16. An annular seal member 53 is interposed between the supporting portion 45a and the crankshaft 16, so that an oil chamber 54 into which the right end portion of the crankshaft 16 projects is formed inside of the supporting portion 45a. An oil passage 55 for introducing the oil from the oil pump 41 into the oil chamber 54 is provided in the crankcase 12 and the right cover 45.

The crankshaft 16 is coaxially formed with a first oil passage 56 having an outer end opening into the oil chamber 54 and an inner end closed at a position substantially corresponding to the ball bearing 18. The crankpin 37 is coaxially formed with a second oil passage 57 opening at one end to the ball bearing 18 and closed at the other end. The outer side surface of the crank web 16a opposed to the ball bearing 18 is formed with an annular mounting recess 58 to which the open end of the second oil passage 57 is exposed. An annular dish-shaped oil transfer plate 59 is fixed by crimping at an outer circumference to the mounting recess 58 so as to cover the open end of the second oil passage 57.

The crankshaft 16 is further formed with a first communication hole 60 for leading the oil from the first oil passage 56 to a space defined between the oil transfer plate 59 and the crank web 16a. The crankpin 37 is further formed with a second communication hole 61 for leading the oil from the second oil passage 57 to the needle bearing 39.

Accordingly, the oil introduced from the oil pump 41 through the oil passage 55 into the oil chamber 54 is supplied through the first oil passage 56, the first communication hole 60, the space between the oil transfer plate 59 and the crank web 16a, the second oil passage 57, and the second communication hole 61 to the needle bearing 39. The crankshaft 16 is further formed with a third communication hole 62 for leading the oil from the first oil passage 56 into a spacing between the crankshaft 16 and the driven gear 49.

The oil supplied to the needle bearing 39 is used for the lubrication between the big end 38a of the connecting rod 38 and the crankpin 37. This oil splashes with rotation of the crankshaft 16. An oil hole 63 for leading a part of this splashed oil to the roller bearing 19 is formed in the other crank web 16b. This oil hole 63 has an axis parallel to the axis of the crankshaft 16.

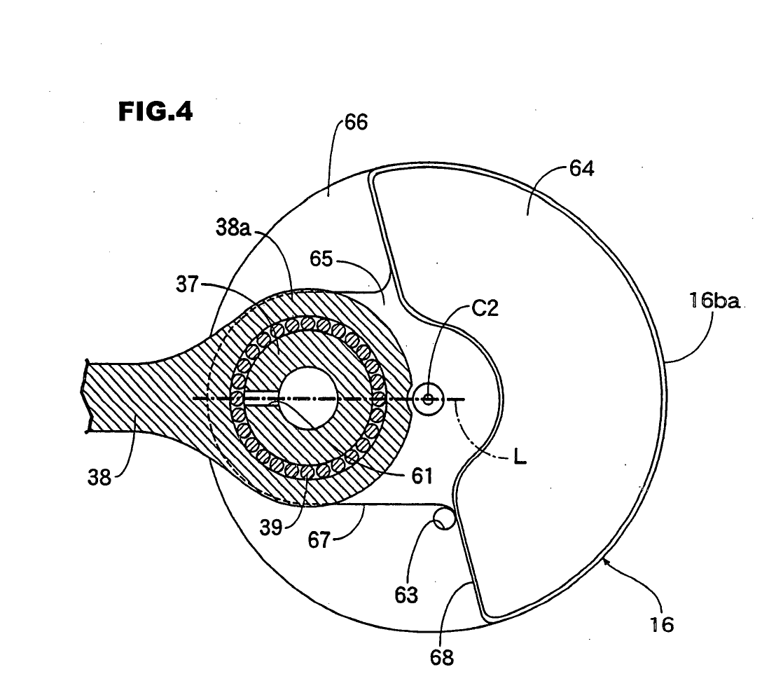

Referring also to FIG. 4, the crank web 16b is formed with a weight portion 16ba opposite to the crankpin 37 with respect to the axis C2 of the crankshaft 16. The inner side surface of the crank web 16b is composed of an arcuate high-level surface 64 corresponding to the weight portion 16ba, a belt-shaped medium-level surface 65 extending between the crankpin 37 and the weight portion 16ba in a direction parallel to a straight line L passing through the axis of the crankpin 37 and the axis C2 of the crankshaft 16, and a low-level surface 66 as the remaining surface. The medium-level surface 65 slightly projects from the low-level surface 66 toward the crank web 16a so that a step portion 67 is formed between the medium-level surface 65 and the low-level surface 66. The high-level surface 64 projects from the medium-level surface 65 toward the crank web 16a so that a step portion 68 is formed between the high-level surface 64 and the low-level surface 66 and between the high-level surface 64 and the medium-level surface 65.

One end of the oil hole 63 opens to the low-level surface 66 near a curved joining portion between the step portions 67 and 68, so that the splashed oil from the needle bearing 39 is easily led through the step portions 67 and 68 to the one end of the oil hole 63.

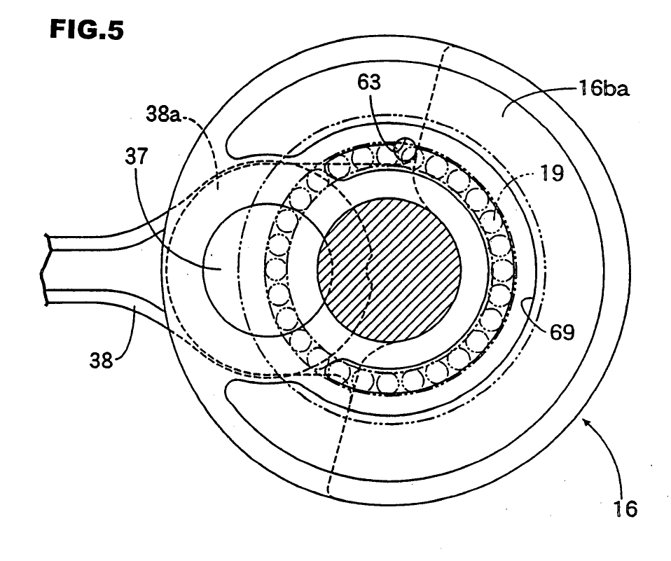

Referring also to FIG. 5, the outer side surface of the crank web 16b opposed to the roller bearing 19 is formed with an arcuate recess 69 so as to substantially correspond to the roller bearing 19. The other end of the oil hole 63 opens to the recess 69. Accordingly, the oil led from the oil hole 63 is easily stored in the recess 69, and splashes from the recess 69 toward the roller bearing 19, thereby allowing the oil supply to the roller bearing 19.

Referring again to FIG. 2, the V-belt type automatic transmission MA is accommodated in a transmission chamber 70 defined in a transmission case 71. The transmission case 71 continues to the engine body 11 so as to cover a part of the engine body 11 on the left side thereof and extends to the left side of the rear wheel WR. The transmission case 71 is composed of an inner case 72 integral with the case member 12b of the crankcase 12, an outer case 73 connected to the inner case 72 so as to cover the inner case 72 on the left side thereof, and a speed reducer case 74 connected to a rear portion of the inner case 72 on the left side thereof. The transmission chamber 70 is formed between the outer case 73 and the unit of the inner case 72 and the speed reducer case 74. Further, a gear chamber 75 is formed between the inner case 72 and the speed reducer case 74.

The V-belt type automatic transmission MA is composed of a drive pulley device 78A mounted on a left end portion of the crankshaft 16 projecting from the crankcase 12 into the transmission chamber 70, a driven pulley device 79A mounted on an output shaft 81 having an axis parallel to the axis of the crankshaft 16 and rotatably supported to the inner case 72 and the speed reducer case 74, and an endless double cogged V-belt 80 for transmitting power from the drive pulley device 78A to the driven pulley device 79A.

The drive pulley device 78A includes a fixed pulley member 82 fixed to the crankshaft 16, a movable pulley member 83 adapted to be moved toward and away from the fixed pulley member 82, and a centrifugal weight 84 adapted to be moved radially outward according to an increase in rotational speed of the crankshaft 16. The movable pulley member 83 is biased toward the fixed pulley member 82 by the radially outward movement of the centrifugal weight 84 according to an increase in rotational speed of the crankshaft 16.

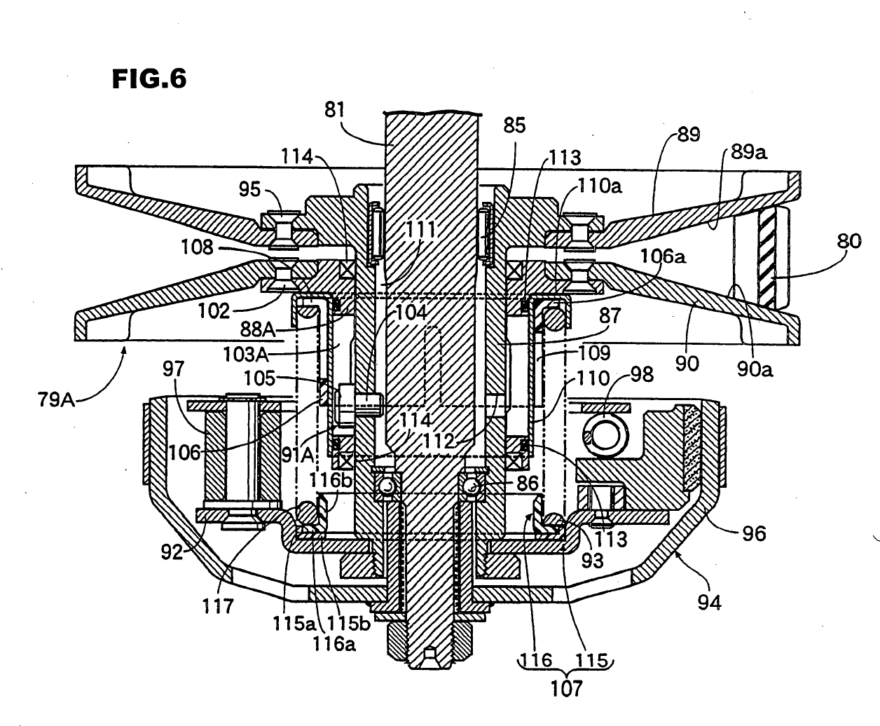

Referring to FIG. 6, the driven pulley device 79A includes an inner sleeve 87, an outer sleeve 88A, a fixed pulley member 89, a movable pulley member 90, a torque cam mechanism 91A, a spring retainer 92, a coil spring 93, and a centrifugal clutch 94. The inner sleeve 87 coaxially surrounds the output shaft 81 with a needle bearing 85 and a ball bearing 86 interposed therebetween. The outer sleeve 88A is slidably engaged with the inner sleeve 87 in such a manner that relative rotation about the axis of the inner sleeve 87 and relative movement in the axial direction of the inner sleeve 87 are allowed. The fixed pulley member 89 is fixed to the inner sleeve 87. The movable pulley member 90 is fixed to the outer sleeve 88A in opposed relationship with the fixed pulley member 89. The torque cam mechanism 91A is provided between the inner sleeve 87 and the outer sleeve 88A so as to apply an axial component force to the fixed and movable pulley members 89 and 90 according to a relative rotational phase difference between the fixed and movable pulley members 89 and 90. The spring retainer 92 is fixed to the inner sleeve 87 at a position where the movable pulley member 90 is interposed between the fixed pulley member 89 and the spring retainer 92. The coil spring 93 is provided in its compressed condition between the movable pulley member 90 and the spring retainer 92 so as to surround the outer sleeve 88A. The centrifugal clutch 94 is provided between the inner sleeve 87 and the output shaft 81 so as to become a power transmitting condition when the engine rotational speed exceeds a predetermined rotational speed.

The double cogged V-belt 80 is wrapped between the drive pulley device 78A and the driven pulley device 79A so as to be nipped between opposed conical surfaces 82a and 83a of the fixed and movable pulley members 82 and 83 of the drive pulley device 78A and between opposed conical surfaces 89a and 90a of the fixed and movable pulley members 89 and 90 of the driven pulley device 79A. In the drive pulley device 78A, the movable pulley member 83 is moved toward the fixed pulley member 82 with an increase in rotational speed of the crankshaft 16, so that the wrap radius of the double cogged V-belt 80 on the fixed and movable pulley members 82 and 83 is increased. Conversely, in the driven pulley device 79A, the wrap radius of the double cogged V-belt 80 on the fixed and movable pulley members 89 and 90 is decreased.

The fixed pulley member 89 of the driven pulley device 79A is fixed to one end of the inner sleeve 87 by a plurality of rivets 95, and the spring retainer 92 is fixed to the other end of the inner sleeve 87. The spring retainer 92 constitutes a part of the centrifugal clutch 94. The centrifugal clutch 94 includes a bowl-shaped outer member 96 fixed to the other end portion of the output shaft 81, a plurality of centrifugal weights 97 pinned to the spring retainer 92 so as to be allowed to rotate about an axis parallel to the axis of the output shaft 81, and a clutch spring 98 provided between each centrifugal weight 97 and the spring retainer 92. When a centrifugal force acting on each centrifugal weight 97 according to the rotation of the spring retainer 92 exceeds a biasing force of each clutch spring 98, each centrifugal weight 97 is brought into frictional engagement with the outer member 96, thereby coupling the inner sleeve 87, i.e., the fixed pulley member 89 and the outer member 96, i.e., the output shaft 81.

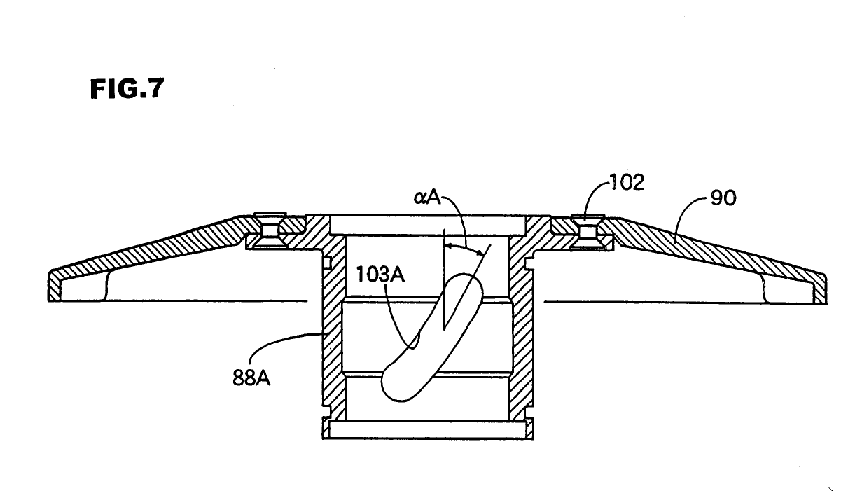

Referring also to FIG. 7, the movable pulley member 90 of the driven pulley device 79A is fixed to one end of the outer sleeve 88A by a plurality of rivets 102 so as to be opposed to the fixed pulley member 89. The torque cam mechanism 91A is known in the art, and it includes a plurality of cam holes 103A formed in the outer sleeve 88A, a cam pin 104 through each cam hole 103A and implanted in the inner sleeve 87, and a roller 105 supported to each cam pin 104 so as to be rolled within each cam hole 103A. Each cam hole 103A is curved so that an angle αA between the center line of an end portion of the cam hole 103A near the movable pulley member 90 and the axis of the outer sleeve 88A is relatively small, in order to make the axial component force applied to the fixed and movable pulley members 89 and 90 relatively small at a top-speed shift position.

The spacing between the fixed pulley member 89 and the movable pulley member 90 of the driven pulley device 79A is determined by the balance among the axial force generated by the torque cam mechanism 91A, the axial elastic force generated by the coil spring 93, and a force applied from the double cogged V-belt 80 in a direction of increasing the spacing between the fixed pulley member 89 and the movable pulley member 90.

The inner circumference of the coil spring 93 is guided by a guide member 106 on the movable pulley member 90 side. Thrust bearing means 107 is interposed between the spring retainer 92 and the coil spring 93.

The guide member 106 is a cylindrical member formed of a self-lubricating resin, and has a flange portion 106a for receiving one end of the coil spring 93 on the movable pulley member 90 side. Thus, the one end of the coil spring 93 is received by the flange portion 106a of the guide member 106, and the inner circumference of the coil spring 93 at a portion on the movable pulley member 90 side is guided by the guide member 106. Further, the guide member 106 is formed with a plurality of axial slits 108 extending from one end toward the other end and a plurality of axial slits 109 extending from the other end toward the one end.

A cylindrical metal collar 110 is interposed between the outer sleeve 88A and the guide member 106. The metal collar 110 has an integral receiving portion 110a at one end having a substantially L-shaped section for receiving the flange portion 106a of the guide member 106 and the one end of the coil spring 93. The metal collar 110 coaxially surrounds the outer sleeve 88A so as to close the cam holes 103A of the outer sleeve 88A.

An annular chamber 111 is formed between the output shaft 81 and the inner sleeve 87 in the axial range between the needle bearing 85 and the ball bearing 86. The annular chamber 111 and each cam hole 103A are filled with grease. The inner sleeve 87 is formed with a communication hole 112 for connecting the annular chamber 111 and each cam hole 103A. Two annular seal members 113 are mounted on the outer circumference of the outer sleeve 88A at its axially opposite end portions so as to be in elastic contact with the inner circumference of the collar 110, and two annular seal members 114 are mounted on the inner circumference of the outer sleeve 88A at its axially opposite end portions so as to be in sliding contact with the outer circumference of the inner sleeve 87.

The thrust bearing means 107 is composed of a pair of bearing members 115 and 116 sandwiched in contact with each other between the coil spring 93 and the spring retainer 92. Each of the bearing members 115 and 116 is formed of a self-lubricating resin. The bearing member 115 is an integral member composed of an engaging cylindrical portion 115a engaged with the side wall of a circular recess 117 formed on the spring retainer 92 and a ringlike flat bearing portion 115b kept in contact with the closed end of the circular recess 117. The other bearing member 116 is also an integral member composed of a ringlike flat bearing portion 116a sandwiched between the bearing portion 115b and the coil spring 93 and a positioning cylindrical portion 116b axially extending from the inner circumference of the bearing portion 116a so as to determine a position relative to the coil spring 93.

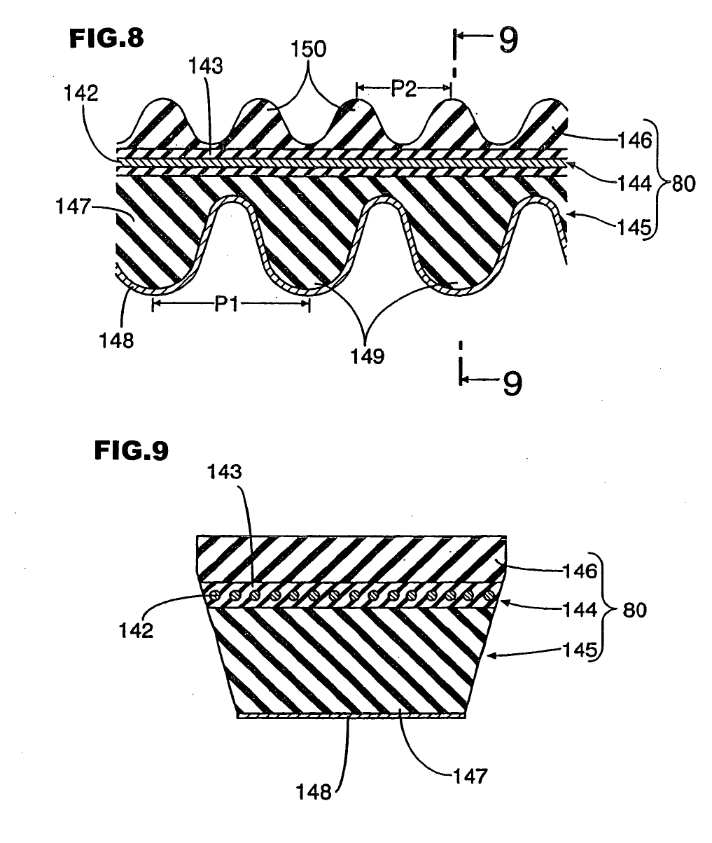

Referring to FIGS. 8 and 9, the double cogged V-belt 80 has an endless core wire embedded portion 144 formed by embedding core wires 142 in a rubber composition 143, a lower cog formed portion 145 provided over the inner circumferential surface of the core wire embedded portion 144, and an upper cog formed portion 146 provided over the outer circumferential surface of the core wire embedded portion 144.

Each core wire 142 is a twist yarn formed from aramid fibers by setting a twist diameter to 1 mm or less, preferably about 0.95 mm, so as to ensure relatively high stiffness of the double cogged V-belt 80 and to prevent a reduction in running durability of the double cogged V-belt 80 due to excessively high stiffness. The rubber composition 143 is formed of chloroprene rubber, ethylene-propylene-diene terpolymer rubber, alkylated chlorosulfonated polyethylene rubber, or hydrogenated NBR, for example.

The lower cog formed portion 145 is composed of a body 147 formed of a rubber composition and a canvas 148 for covering the lower surface of the body 147. The lower cog formed portion 145 is formed with a plurality of lower cogs 149 arranged with a given pitch P1 in the longitudinal direction of the V-belt 80.

The upper cog formed portion 146 is formed of a rubber composition, and it is formed with a plurality of upper cogs 150 arranged with a given pitch P2 in the longitudinal direction of the V-belt 80.

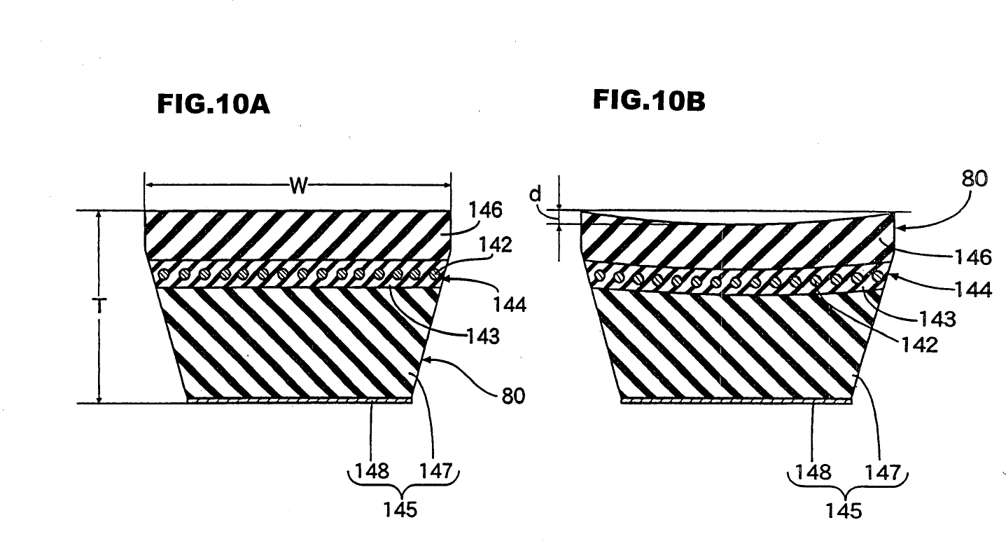

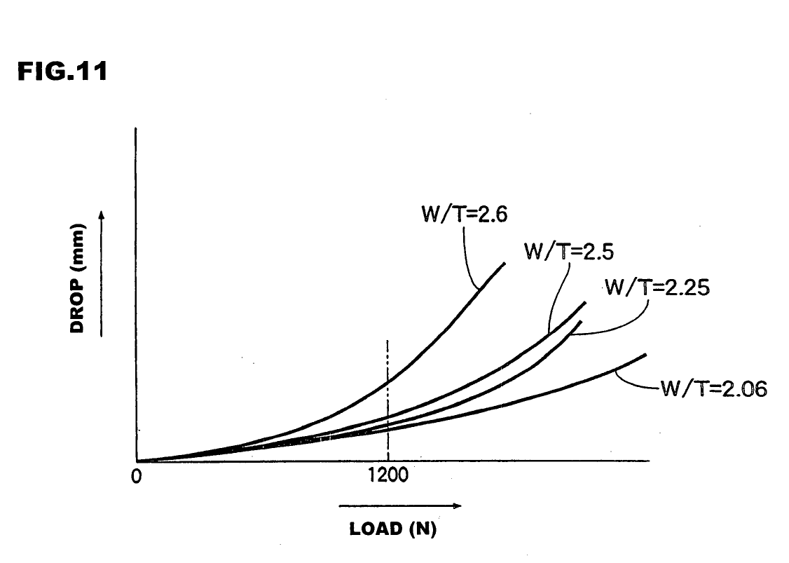

FIG. 10(a) shows a transverse section of the double cogged V-belt 80 in the condition where no load is applied, and FIG. 10(b) shows a similar section of the V-belt 80 in the condition where the V-belt 80 is deformed so that a transversely central portion of the upper cog formed portion 146 drops more with an increase in load applied by the operation of the V-belt type automatic transmission MA. FIG. 11 shows the deformation characteristics of the double cogged V-belt 80 such that the drop d of the upper cog formed portion 146 changes with changes in load applied with the ratio (W/T) of the width W of the V-belt 80 to the thickness T of the V-belt 80 being varied as a parameter.

The normal load range in the V-belt type automatic transmission MA is a range of not greater than 1200 N, for example. As apparent from FIG. 11, when W/T is 2.5 or less, the drop d is small and proportionally changes with changes in load in the normal load range. In other words, W/T must be set to 2.5 or less, so as to suppress the deformation of the double cogged V-belt 80 according to changes in load.

In setting W/T to 2.5 or less, the upper cogs 150 of the upper cog formed portion 146 of the double cogged V-belt 80 are formed so that the drop d of the upper cog formed portion 146 proportionally changes with changes in load applied to the V-belt 80.

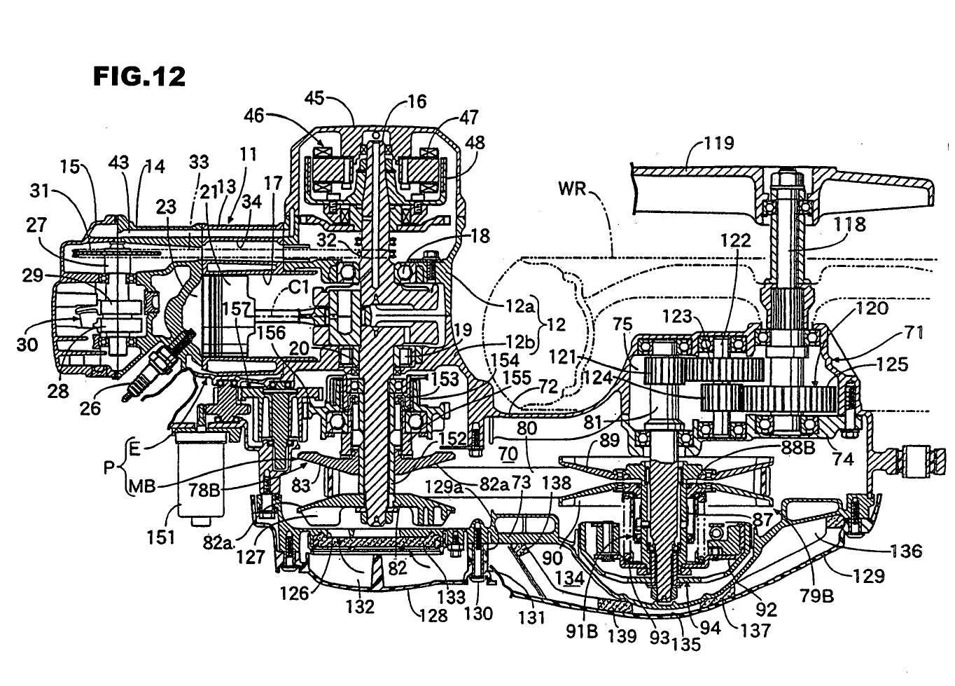

The double cogged V-belt 80 is applicable to either the V-belt type automatic transmission MA shown in FIG. 2 or a V-belt type automatic transmission MB shown in FIG. 12. Referring to FIG. 12, the V-belt type automatic transmission MB is composed of a drive pulley device 78B mounted on a left end portion of the crankshaft 16 projecting from the crankcase 12 into the transmission chamber 70, a driven pulley device 79B mounted on the output shaft 81, and the double cogged V-belt 80 for transmitting power from the drive pulley device 78B to the driven pulley device 79B.

The drive pulley device 78B includes a fixed pulley member 82 fixed to the crankshaft 16, a movable pulley member 83 adapted to be moved toward and away from the fixed pulley member 82, and an electric motor 151 as an actuator for changing the distance between the fixed pulley member 82 and the movable pulley member 83 according to a shift command.

A cylindrical sleeve 152 is mounted on the crankshaft 16 so as to surround the crankshaft 16, and the movable pulley member 83 is axially slidably supported to the sleeve 152. A cylindrical screw shaft 153 is fixed to the inner case 72 of the transmission case 71 so as to surround the sleeve 152. A nut 154 is threadedly engaged with the screw shaft 153 and is rotatably supported to a support sleeve 155 so that axial relative movement is inhibited. The support sleeve 155 is connected to the movable pulley member 83 so as to coaxially surround the sleeve 152 so that axial relative movement is allowed and relative rotation about the axis of the sleeve 152 is inhibited. The nut 154 is formed with a driven gear 156. An output from the electric motor 151 is transmitted through a speed reducing gear mechanism 157 to the driven gear 156.

According to the drive pulley device 78B, all of the nut 154, the support sleeve 155, and the movable pulley member 83 are moved toward or away from the fixed pulley member 82 in the axial direction of the crankshaft 16 by the operation of the electric motor 151. Accordingly, the spacing between the fixed pulley member 82 and the movable pulley member 83 is adjusted.

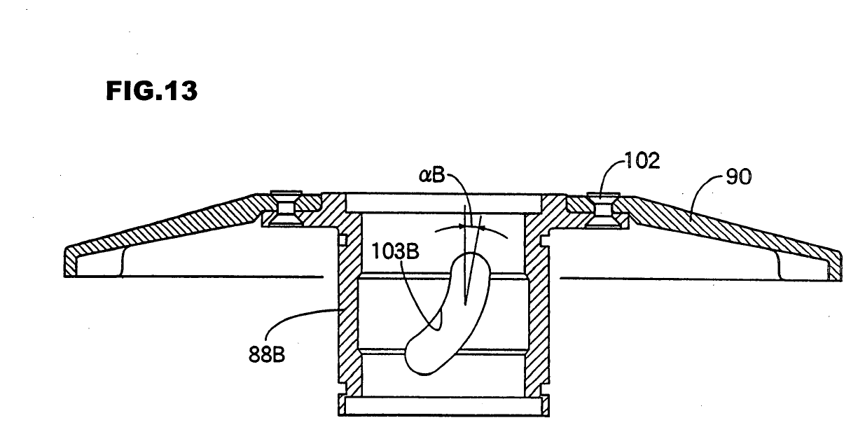

The driven pulley device 79B basically has a configuration similar to that of the driven pulley device 79A shown in FIGS. 2 and 6. However, as shown in FIG. 13, the driven pulley device 79B has a torque cam mechanism 91B including a plurality of cam holes 103B formed in an outer sleeve 88B, and each cam hole 103B is different in shape from each cam hole 103A shown in FIG. 7.

As similar to each cam hole 103A, each cam hole 103B is curved so that an angle αB between the center line of an end portion of the cam hole 103B near the movable pulley member 90 and the axis of the outer sleeve 88B is relatively small, in order to make the axial component force applied to the fixed and movable pulley members 89 and 90 relatively small at a top-speed shift position. However, the angle αB is set smaller than the angle αA of each cam hole 103A in the torque cam mechanism 91A of the driven pulley device 79A shown in FIG. 7.

Thus, the torque cam angles of the torque cam mechanisms 91A and 91B in the driven pulley devices 79A and 79B are set different from each other according to whether the V-belt type automatic transmission MA using the centrifugal weight 84 in the drive pulley device 78A or the V-belt type automatic transmission MB using the electric motor 151 in the drive pulley device 78B is selected. In the V-belt type automatic transmission MB allowing more precise shift control by the operation of the electric motor 151, the axial component force generated by the torque cam mechanism 911B at the top-speed shift position is set smaller.

Referring again to FIG. 2, an axle 118 for the rear wheel WR is rotatably supported to the speed reducer case 74 and the inner case 72, and a right end portion of the axle 118 projecting from the transmission case 71 is rotatably supported to an arm 119 connected to the engine body 11 and extending to the right side of the rear wheel WR.

A speed reducing gear train 120 is provided between the output shaft 81 and the axle 118 and accommodated in the gear chamber 75. The speed reducing gear train 120 is composed of a first gear 121 provided on the output shaft 81, a second gear 123 provided on an intermediate shaft 122 and meshing with the first gear 121, a third gear 124 provided on the intermediate shaft 122, and a fourth gear 125 provided on the axle 118 and meshing with the third gear 124. The intermediate shaft 122 is rotatably supported to the inner case 72 and the speed reducer case 74 so as to extend in parallel to the output shaft 81 and the axle 118.

An outside air inlet hole 126 for taking a cooling air into the transmission chamber 70 is formed through a side wall portion of the outer case 73 of the transmission case 71 opposed to the drive pulley device 78A. The fixed pulley member 82 of the drive pulley device 78A is integrally formed at its outer circumference with a cooling fan 127 for dispersing the cooling air taken from the outside air inlet hole 126 into the transmission chamber 70.

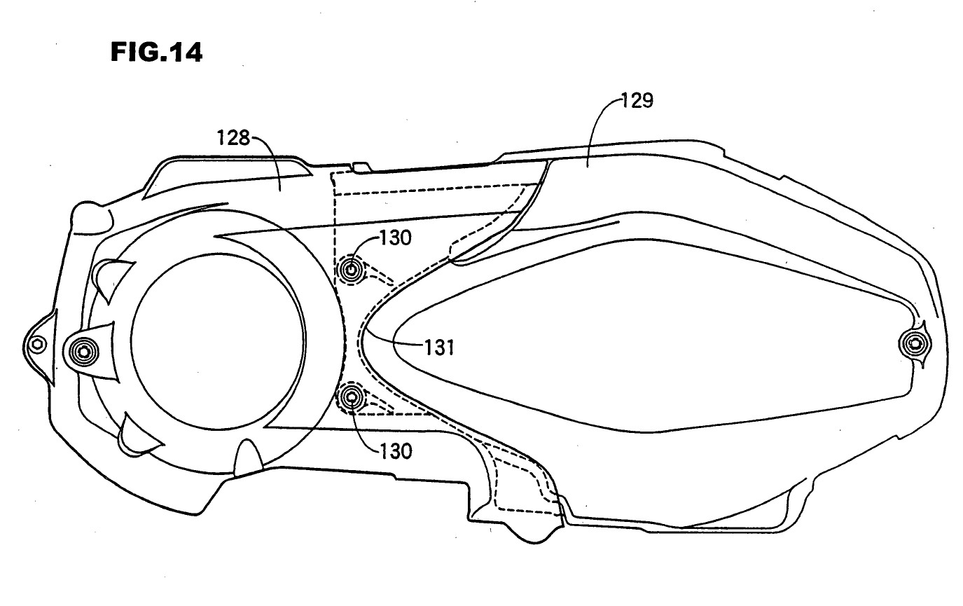

Referring also to FIG. 14, the outer side surface of the transmission case 71 is covered with a case cover 128 and a sound insulating cover 129. The case cover 128 is fastened to the outer case 73 of the transmission case 71 at a plurality of positions so as to cover the outer side surface of a front half portion of the transmission case 71 including a portion for forming the outside air inlet hole 126. The sound insulating cover 129 is also fastened to the outer case 73 of the transmission case 71 at a plurality of positions so as to cover the outer side surface of a rear half portion of the transmission case 71 at a position corresponding to the driven pulley device 79A.

The case cover 128 and the sound insulating cover 129 are mounted on the transmission case 71 in such a manner that the front edge portion of the sound insulating cover 129 is covered with the rear edge portion of the case cover 128. The front edge portion of the sound insulating cover 129 is formed with two boss portions 129a, which are sandwiched between the rear edge portion of the case cover 128 and the transmission case 71. Thus, the rear edge portion of the case cover 128 and the front edge portion of the sound insulating cover 129 are fastened to the transmission case 71 by two screw members 130 inserted into the boss portions 129a.

An air inlet hole 131 opening rearward of the vehicle is formed between the rear edge portion of the case cover 128 and the front edge portion of the sound insulating cover 129. Further, an air introduction chamber 132 communicating with the air inlet hole 131 is formed between the case cover 128 and the transmission case 71.

A filter 133 is mounted on the outer side surface of the transmission case 71 so as to close the outside air inlet hole 126 on the air introduction chamber 132 side. Accordingly, the outside air introduced from the air inlet hole 131 into the air introduction chamber 132 is passed through the filter 133, so that the resultant clean air is taken into the transmission chamber 70.

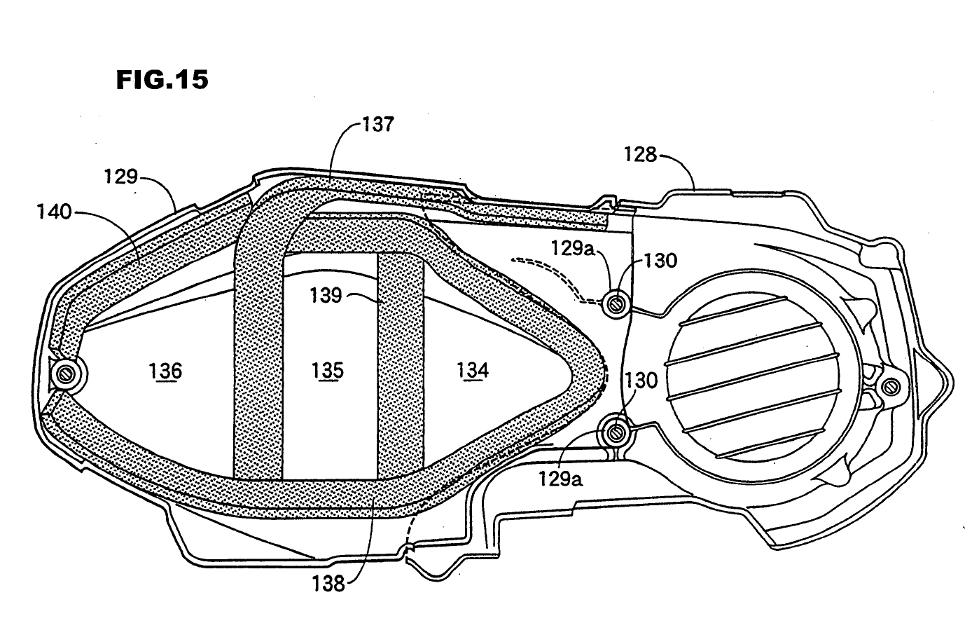

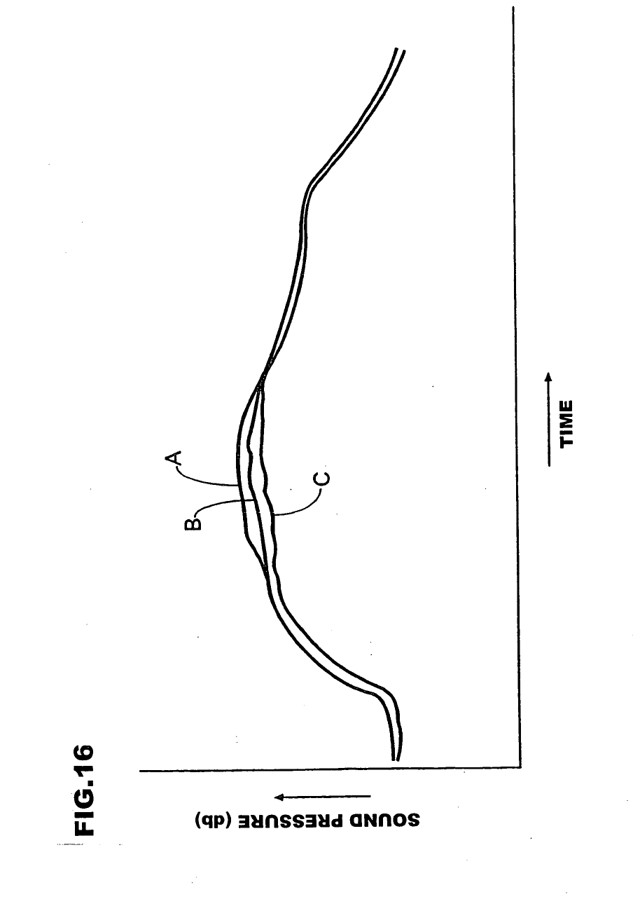

Referring also to FIG. 15, four sound absorbing members 137, 138, 139, and 140 are provided between the transmission case 71 and the sound insulating cover 129 so as to partition the space between the transmission case 71 and the sound insulating cover 129 into three closed spaces 134, 135, and 136.

Each of the sound absorbing members 137 to 140 is formed like a strip by cutting a polyurethane sheet. One surface of each of these sound absorbing members 137 to 140 is bonded to the inner surface of either the transmission case 71 or the sound insulating cover 129, preferably to the inner surface of the sound insulating cover 129 as in this preferred embodiment by means of adhesive.

The operation of this preferred embodiment will now be described. In the driven pulley device 79A or 79B of the V-belt type automatic transmission MA or MB, the inner circumference of at least the coil spring 93 is guided by the guide member 106 on the movable pulley member 90 side, and the thrust bearing means 107 is interposed between the spring retainer 92 and the coil spring 93. Accordingly, the coil spring 93 can be rotated with the movable pulley member 90 so that no relative rotation therebetween occurs, and it is therefore possible to prevent the occurrence of torsion of the coil spring 93. Further, since the inner circumference of the coil spring 93 is guided by the guide member 106 on the movable pulley member 90 side, the inner circumference of the coil spring 93 can be centered to thereby prevent the occurrence of waving of the coil spring 93.

In particular, the amount of operation of the half portion of the coil spring 93 on movable pulley member 90 side is relatively large according to the axial movement of the movable pulley member 90. Accordingly, by providing the guide member 106 for guiding the inner circumference of the half portion of the coil spring 93 whose operational amount is relatively large as mentioned above, the occurrence of waving of the coil spring 93 can be prevented more effectively.

The thrust bearing means 107 is configured by simply sandwiching the bearing members 115 and 116 between the coil spring 93 and the spring retainer 92. Thus, the thrust bearing means 107 has a very simple structure. Furthermore, each of the bearing members 115 and 116 is formed of a self-lubricating resin. Therefore, even if the cooling air introduced into the transmission chamber 70 contains dust, the wear resistance of the thrust bearing means 107 against the dust can be improved.

The guide member 106 is also formed of a self-lubricating resin, so that the slidability between the guide member 106 and the inner circumference of the coil spring 93 on the movable pulley member 90 side can be improved. As a result, the gap between the coil spring 93 and the guide member 106 can be minimized, thereby more effectively preventing the occurrence of waving of the coil spring 93 to improve the operability of the coil spring 93.

Further, the metal collar 110 is interposed between the outer sleeve 88A or 88B and the guide member 106. Accordingly, the wall thickness of the guide member 106 can be set small, so that the gap between the guide member 106 and the inner circumference of the coil spring 93 can be easily controlled in association with thermal expansion of the resin guide member 106. The difference in coefficient of friction of the coil spring 93 between to the movable pulley member 90 and to the spring retainer 92 can be retained and relative rotation between the coil spring 93 and the spring retainer 92 can be generated more reliably.

The double cogged V-belt 80 having the endless core wire embedded portion 144 in which the core wires 142 are embedded, the lower cog formed portion 145 provided over the inner circumference of the core wire embedded portion 144, and the upper cog formed portion 146 provided over the outer circumference of the core wire embedded portion 144 can be used commonly for the drive pulley device 78A having the centrifugal weight 84 for changing the distance between the fixed pulley member 82 and the movable pulley member 83 and for the drive pulley device 78B having the electric motor 151 for changing the distance between the fixed pulley member 82 and the movable pulley member 83 according to a shift command. Accordingly, the number of parts can be reduced.

The double cogged V-belt 80 has the core wires 142 formed from aramid fibers, and the ratio (W/T) of the width W of the V-belt 80 to the thickness T of the V-belt 80 is set to 2.5 or less. Accordingly, the stiffness of the V-belt 80 can be set relatively high and the deformation of the V-belt 80 with changes in load can be suppressed. As a result, in response to fluctuations of input torque from the drive pulley device 78A or 78B, the V-belt 80 can suitably transmit power to the driven pulley device 79A or 79B so that the torque cam mechanism 91A or 91B generates a suitable axial component force, thus extending the life of the V-belt 80 and improving the shift response.

The torque cam angles of the torque cam mechanisms 91A and 911B in the driven pulley devices 79A and 79B are set different from each other according to whether the drive pulley device 78A having the centrifugal weight 84 or the drive pulley device 78B having the electric motor 151 is selected. Accordingly, in selecting either the drive pulley device 78A or the drive pulley device 78B, it is only necessary to prepare the torque cam mechanisms 91A and 911B having different torque cam angles as one component of the drive pulley devices 79A and 79B, and the other components of the drive pulley devices 79A and 79B can be used commonly. Further, suitable axial component forces can be generated by the torque cam mechanisms 91A and 91B in the driven pulley devices 79A and 79B.

The space between the transmission case 71 and the sound insulating cover 129 mounted on the transmission case 71 so as to cover the outer side surface of the transmission case 71 is partitioned into the plural closed spaces 134 to 136 by the sound absorbing members 137 to 140. Accordingly, noise produced from the transmission case 71 is absorbed by the sound absorbing members 137 to 140 provided between the transmission case 71 and the sound insulating cover 129. Moreover, sound resonance can be prevented by forming the plural closed spaces 134 to 136 between the transmission case 71 and the sound insulating cover 129. Thus, a sufficient noise suppression effect can be obtained with such a simple structure that the space between the transmission case 71 and the sound insulating cover 129 is partitioned into the plural closed spaces 134 to 136 by the sound absorbing members 137 to 140.

FIG. 16 shows the test results obtained by measuring noise produced at acceleration of the motorcycle in various conditions including a condition A where no sound absorbing members are provided between the sound insulating cover 129 and the transmission case 71, a condition B where a sound absorbing member is provided over the entire space between the sound insulating cover 129 and the transmission case 71, and a condition C where the sound absorbing members 137 to 140 are provided in the space between the sound insulating cover 129 and the transmission case 71 to partition this space into the plural closed spaces 134 to 136. As apparent from FIG. 16, an excellent noise suppression effect can be obtained in the condition C according to the present invention.

Each of the sound absorbing members 137 to 140 is formed like a strip by cutting a polyurethane sheet, and one surface of each of the sound absorbing members 137 to 140 is bonded to either the transmission case 71 or the sound insulating cover 129, preferably to the sound insulating cover 129 as in this preferred embodiment by means of adhesive. Accordingly, as compared with a conventional structure using a sound absorbing sheet having a shape corresponding to the shape of the sound insulating cover 129, the yield in forming the sound absorbing members 137 to 140 can be improved. Further, the sound insulating cover 129 can be mounted to the transmission case 71 in the condition where the sound absorbing members 137 to 140 are bonded to either the transmission case 71 or the sound insulating cover 129. Accordingly, the productivity in assembling the power unit P can be improved.

The outside air inlet hole 126 for taking the cooling air into the transmission chamber 70 is formed through the side wall of the transmission case 71 at a position opposed to the drive pulley device 78A or 78B of the V-belt type automatic transmission MA or MB accommodated in the transmission chamber 70. On the other hand, the sound insulating cover 129 is formed so as to cover a substantially half portion of the outer side surface of the transmission case 71 at a position opposed to the driven pulley device 79A or 79B of the V-belt type automatic transmission MA or MB. Accordingly, the sound absorbing members 137 to 140 can be provided between the transmission case 71 and the sound insulating cover 129 without consideration of the outside air inlet hole 126 of the transmission case 71, thereby improving the productivity.

Having thus described a preferred embodiment of the present invention, it should be noted that the present invention is not limited to the above preferred embodiment, but various design changes may be made without departing from the scope of the present invention as defined in the claims.

1. A V-belt type automatic transmission comprising:
a drive pulley device having a first fixed pulley member and a first movable pulley member opposed to said first fixed pulley member with the distance therebetween being changeable;
a driven pulley device having a second fixed pulley member, a second movable pulley member rotatable relative to said second fixed pulley member about an axis thereof and axially movable relative to said second fixed pulley member;
a torque cam mechanism for applying an axial component force to said second fixed pulley member and said second movable pulley member according to a relative rotational phase difference between said second fixed pulley member and said second movable pulley member;
a coil spring for exerting a spring force for biasing said second movable pulley member toward said second fixed pulley member; and
a double cogged V-belt wrapped between said drive pulley device and said driven pulley device so as to be nipped between said first fixed pulley member and said first movable pulley member and between said second fixed pulley member and said second movable pulley member, said double cogged V-belt having an endless core wire embedded portion in which core wires are embedded, a lower cog formed portion provided over the inner circumference of said core wire embedded portion, and an upper cog formed portion provided over the outer circumference of said core wire embedded portion
wherein each of said core wires is formed from aramid fibers, and the ratio (W/T) of the width W of said V-belt to the thickness T of said V-belt is set to 2.5 or less.

2. A V-belt type automatic transmission according to claim 1, wherein said drive pulley device alternatively comprises either a centrifugal weight for changing the distance between said first fixed pulley member and said first movable pulley member or an actuator for changing the distance between said first fixed pulley member and said first movable pulley member according to a shift command.

3. A V-belt type automatic transmission according to claim 2, wherein said torque cam mechanism has different torque cam angles according to which of said centrifugal weight and said actuator is comprised in said drive pulley device.
